(19) United States
(12) Patent Application Publication
(10) Pub. No.: US 2022/0053573 A1
(43) Pub. Date: Feb. 17, 2022

(54) METHOD AND APPARATUS FOR UE INFORMATION TRANSMISSION FOR NETWORK OPTIMIZATION

(71) Applicant: LENOVO (BEIJING) LIMITED, Beijing (CN)

(72) Inventors: Jie Shi, Beijing (CN); Lianhai Wu, Beijing (CN); Jing Han, Beijing (CN); Haiming Wang, Beijing (CN); Zhi Yan, Beijing (CN)

(21) Appl. No.: 17/276,412

(22) PCT Filed: Sep. 27, 2018
(86) PCT No.: PCT/CN2018/108053

§ 371 Date: Mar. 15, 2021

(51) Int. Cl. H04W 74/08; H04W 24/10; H04W 24/02

(52) U.S. Cl. CPC H04W 74/0841; H04W 24/02; H04W 24/10

(57) ABSTRACT

A method and apparatus for UE information transmission for network optimization are disclosed. The method comprises: transmitting the UE information to the eNB (e-NodeB), wherein the UE information includes RA preamble transmission information and its CE (coverage enhancement) level information or includes RLF report and its CE level information.

### FIELD

The subject matter disclosed herein relates generally to wireless communications, and more particularly relates to a method and apparatus for UE information transmission for network optimization.

### BACKGROUND

The following abbreviations are herewith defined, at least some of which are referred to within the following description: Third Generation Partnership Project (“3GPP”), New Radio

(“NR”), Integrated Access and Backhaul (“IAB”), Time-Division Multiplexing (“TDM”), Downlink Control Information (“DCI”), Uplink (UL), Downlink (DL), Radio Resource Control (“RRC”), Radio Network Temporary Identifier (“RNTI”), User Entity/Equipment (Mobile Terminal) (UE).

In LTE the self-organizing networks (SON) function is provided to support network configuration, tuning and optimization. However, in NB-IOT network the support for SON function is lack at UE end.

NB-IoT network has achieved a commercial success, and the number of deployed networks and the volume of connected devices are undergoing a steady growth. To support this growth NB-IoT network is enhanced in Release 16 to further improve the network operation and efficiency in a range of areas including network management tool enhancement, specifically, SON function supports for reporting of random access performance and radio link failure (RLF), if needed. This facilitates the improvement of the observability and control of random access performance and coverage.

### References

R2-166568, Ericsson

### BRIEF SUMMARY

In order to achieve the purpose of the invention, a method and apparatus for UE information transmission for network optimization are disclosed.

In one embodiment, a method at UE (user equipment) for transmitting UE information in a wireless communication system, the method comprising: transmitting the UE information to the eNB (e-NodeB), wherein the UE information includes RA (random access) preamble transmission information and its CE (coverage enhancement) level information or includes RLF report and its CE level information.

In one embodiment, a method at eNB for receiving UE information in a wireless communication system, the method comprising: receiving the UE information from the UE, wherein the UE information includes RA preamble transmission information and its CE level information or includes RLF report and its CE level information.

In one embodiment, a UE for reporting UE information to an eNB, the UE comprising: a transceiver; a processor is configured to control the transceiver to: receive a request to report UE information for a RA procedure from an eNB; report the UE information to the eNB in response to the request, wherein the UE information includes RA preamble transmission information and its CE level information or includes RLF report and its CE level information.

In one embodiment, An eNB for receiving UE information from a UE, the eNB comprising: a transceiver; a processor is configured to control the transceiver to: transmit a request to report UE information for a RA procedure to the UE; receive the UE information in response to the request from the UE, wherein the UE information includes RA preamble transmission information and its CE level information or includes RLF report and its CE level information.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic diagram illustrating legacy LTE UE reporting procedure for SON;

FIG. 2 is a schematic flow chart diagram illustrating a method for UE information transmission in NB-IoT network according to one embodiment;

FIG. 3 is a schematic diagram illustrating a procedure for eNB to optimize the NB-IoT network according to one embodiment; FIG. 4 is a schematic flow chart diagram illustrating a method for UE information transmission in NB-IoT network according to another embodiment;

FIG. 5 is a schematic diagram illustrating the UE information transmission according to one embodiment;

FIG. 6 is a schematic block diagram illustrating apparatuses according to one embodiment.

### DETAILED DESCRIPTION

As will be appreciated by one skilled in the art, aspects of the embodiments may be embodied as a system, apparatus, method, or program product. Accordingly, embodiments may take the form of an entire hardware embodiment, an entire software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code. Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which executes on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

In legacy LTE specification for SON, in RA reporting the information on the number of RA preamble will be transmitted if RA is successful, and in RLF reporting the information on failed PScell ECGI (E-UTRAN cell global identifier), the measurement result of serving cell and neighbor cell and the RLF cause will be transmitted if RA procedure is failed.

In the contribution R2-166568 Mobility enhancements in NB-IOT R14 from Ericsson, it also disclosed that SON based on RLF reporting should be supported.

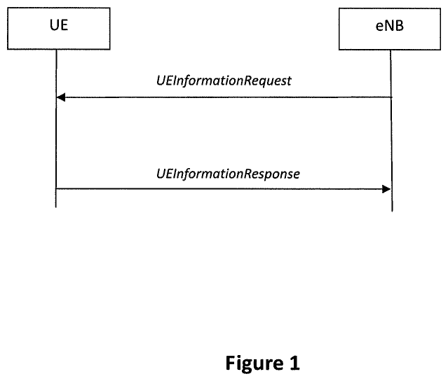

FIG. 1 is a schematic diagram illustrating legacy LTE UE reporting procedure for SON.

In legacy LTE, the SON function is supported by UE information request message (UEInformationRequest) from eNB to UE, and the UE information response message (UEInformationResponse) from UE to eNB as depicted in FIG. 1.

In the UE information request message, the eNB will configure the response information element the eNB wants to get from UE, such as the RA information and RLF report information. Then the UE will report its information in the UE information response message based on the UE information request message. Based on this request-response mechanism, the network will optimize its parameters for RA performance or coverage.

According to current parameters transmitted in UEInformationResponse message, the RA information is the RA preamble number. Its definition is as below:

UEs which receive polling signaling shall report the below information:

Number of RACH preambles transmitted until the successful RACH completion;

Contention resolution failure.

The RLF information UEInformationResponse message is complex, it mainly includes last serve cell measurement results, neighbor cell measurement results, failed PScell ID information, location information, timestamp, sever cell RSRP, neighbor cell RSRP, RLF cause when RLF happens. More information about the RLF report could be seen in 36.331 VarRLF-Report parameter.

As we know, the random access procedure for a NB-IOT UE is different from that for a non-NB-IOT UE. For a NB-IOT UE, the RA procedure is associated with UE CE (coverage enhancement) level. The CE level defines the possible UE power level to connect to the network. So far, the network defined two or three thresholds for CE level, the threshold is the criterion for UEs to select a PRACH (physical random access channel) resource. For example, the network configures two RSRP threshold, threshold 1 and threshold 2, RSRP in threshold1 is larger than RSRP in threshold2. If UE measure result is lower than threshold 2, UE will be in CE level2. Else if UE measure result is lower than threshold 1, UE will be in CE level1, else UE will be in CE level0. eNB configures independent RA profile for each CE level, including the resource in the time domain and frequency domain, power adjustment setting and etc..

UE needs to determine its initial CE level in a RA procedure based on its RSRP value. After determining the CE level, the random access procedure is initiated. If the access to the RA resource corresponding to the CE level fails, the UE will transfer to the next CE level (CE level+1) and continue to initiate the random access procedure until the deepest level. In the case where the number of RA preamble transmitted reaches a maximum, the RA procedure is failed.

For example, in the RA procedure, the CE level will be increased if the number of RA preamble transmissions in this CE level is larger than the maxNumPreambleAttemptCE that is the maximum number for RA preamble transmissions in its corresponding CE level. In the increased CE level, UE will choose its preamble and its resource based on the configuration for the increased CE level transmitted via the SIB information. If the total number of RA preamble transmissions in one RA procedure is larger than the preambleTransMax-CE, the RA is failed. Otherwise, UE will connect to network successfully, and the current CE level in RA successful occasion is the CE level UE working with. Please note, UE will stay in a possible last CE level once it is in it. It can be seen than UE may go through multiple CE levels in one RA procedure. The number of RA preamble transmitted could be also defined as the number of preamble transmission attempts in the PRACH resource, or as the number of multiplying of the number of preamble transmission attempts in the PRACH resource and the number of PRACH repetitions per attempt in the PRACH resource, or as an integrated concept of the number of preamble transmission attempts in the PRACH resource and the number of PRACH repetitions per attempt in the PRACH resource. Therefore, in the specification, we do not distinguish these definitions. In addition, in the specification, PRACH could be NPRACH.

The current UE information of SON reporting for RA only includes the parameter related to the number of preamble transmissions. This information is not enough for supporting NB-IOT SON. For example, with an assumption that the preamble transmissions with a total number of 30 is reported to eNB, eNB does not know the UE's CE level information related to this number 30, therefore the eNB will not know how to adjust the RA configuration of NB-IOT, which is defined based on CE level.

According to the above analyses, it is beneficial to report the CE level information on RA for RA performance and coverage optimization. Therefore reasonable parameters are needed to report the CE level information for a successful RA procedure. Besides, the number of RA preamble transmissions and its CE level information in a RLF procedure is also meaningful for NB-IOT SON, since it is helpful for eNB to adjust the RA or coverage configuration to avoid RLF.

On the other hand, from the view of message transmitting/receiving procedure, it is needed to transmit the parameters on SON in a power saving procedure.

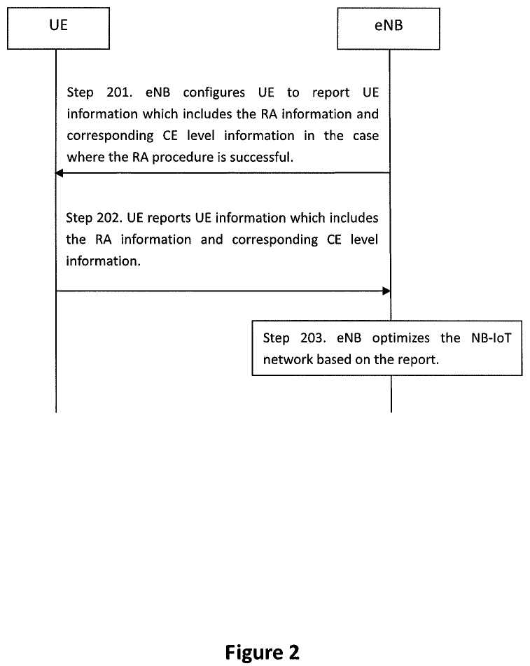

FIG. 2 is a schematic flow chart diagram illustrating a method for UE information transmission in NB-IoT network according to one embodiment.

As in FIG. 2, the basic solution to RA reporting procedure for NB-IOT network is shown.

At step 201, the eNB configures the UE to report its UE information which will include the RA information, besides, the information associated with the CE level in RA procedure will also be requested. The configuration could be set by a Boolean value. This Boolean value is used to indicate whether the UE shall report information associated with CE level in the report.

At step 202, the UE reports UE information which will include the RA information. Also, the information associated with the CE level in RA procedure will also be reported. The information associated with RACH preamble and CE level could be transmitted based at least one of following options in the case where the RA procedure is successful.
Option1, the number of RA preambles transmitted until the RA procedure is successful, and the CE level when the RA procedure is successful.
If eNB receives the information with option 1, eNB could at least know that the RA configuration for this reported CE level results in a successful connection. The number of RA preambles transmitted in option 1 could be used to evaluate whether the RA resource needs to be adjusted. For example, if the number of RA preamble reported by option 1 is smaller than or equal to a threshold set by eNB for the SON implementation, it means that UE could access the network easily. Otherwise, if the number of RA preamble reported by option 1 is larger than the threshold set by eNB for the SON implementation, it means that UE is difficult to access the network. In this case, eNB will increase the RA resource for UE access, such as the subcarrier resource or time resource, or adjust the RSRP threshold for this CE level to make coverage range to be smaller than the current value.
Option2, the number of RA preambles transmitted in each CE level. This information configured by network or indicated by the related standard.
For example, there are three CE levels in the current NB-IOT specification, UE needs to report the number of RA preambles transmitted in each CE level of these three CE levels, or in the CE level configured by dedicated RRC message or system information block. There are multiple CE levels UE may go through for one RA procedure. For example, there are 3 CE levels, and the maximum number of RA preambles transmitted in each CE level is 20. If the number of RA preambles transmitted reaches to 20 in one CE level, it will turn to the next CE level, and if it reaches the CE level with the smallest coverage (e.g. CE level0) the UE will stay in this CE level for multiple rounds for RA procedure. For example, the total number of RA preambles transmitted is 80, the number of RA preambles transmitted in the last CE level0 is 60, the number of RA preambles transmitted in the CE level1 is 20, and the number of RA preambles transmitted in the CE level 2 is 0. eNB may adjust the RA configuration for each CE level based on this information. The CE level2 with number 0 means UE does not initiate RA procedure from this level, so no extra SON option will be trigged for the RA configuration for this CE level. However, for CE level1 and CE level0, the RA configuration could be adjusted based on the reported information. Especially for CE level1, the number of RA preambles transmitted in this CE level reaches the threshold, so the network optimization for this level could be increasing the RA resource for UE access, such as the subcarrier resource or time resource, or adjusting the RSRP threshold for this CE level to make coverage range to be smaller than current value.
Option3, the number of RA preambles transmitted in each CE level the UE has been in during the RA procedure.
This method could reduce the message size for information reporting. For example, if UE only goes through two CE levels, UE will just report the RA information associated with these two CE levels instead if each CE level.
Option4, the number of RA preambles transmitted until the RA procedure is successful and the number of RA preambles transmitted in the last CE level when the RA procedure is successful.
Option4a, the number of RA preambles transmitted until the RA procedure is successful, the number of RA preambles transmitted in the last CE level when the RA procedure is successful and the number of RA preambles transmitted in the last round of the last CE if the UE circularly stay in the last CE level for several rounds. In some cases, based on the information in option4, eNB could logically compute the number of RA preambles transmitted in the other CE level. For example, there are 3 CE levels, and the maximum number of RA preambles transmitted in each CE level is 20. If the number of RA preambles transmitted until the RA procedure is successful is 35, and the number of RA preambles transmitted in CE level1 is 15, eNB could compute that UE transmitted 20 RA preambles at CE level2. The network optimization could be executed to CE level2 since UE is failed to access to the network at CE level2. Based on option 4a, eNB could also know the number of RA preambles transmitted in the last CE level when the RA procedure is successful. For example, the number of times for the UE circularly stay in the last CE level is n, the number of RA preambles transmitted in the last round of the last CE is 10, the total number of RA preambles transmitted in last CE level could be n*the maximum number of RA preamble transmitted in last CE level+10, or could be (n−1)*the maximum number of RA preamble transmitted in last CE level+10. Here, the number of times for the UE circularly stay in the last CE level is the number of times for UE achieved the maximum number of RA preamble transmitted in the last CE level.
Option5, the CE level(s) in the whole RA procedure, the number of times for the UE circularly stay in the last CE level when the RA procedure is successful.
Option5a, the CE level(s) in the whole RA procedure, the number of times for the UE circularly stay in the last CE level when the RA procedure is successful and the number of RA preambles transmitted in the last round of the last CE if that UE circularly stay in the last CE level when the RA procedure is successful.
Option5b, the CE level(s) in the whole RA procedure, the number of times for the UE circularly stay in the last CE level when the RA procedure is successful and the number of RA preambles transmitted in last CE level if that UE circularly stay in the last CE level when the RA procedure is successful.
Based on the CE levels in the whole RA procedure, and the configured maximum number of RA preambles transmitted in each CE level by eNB, eNB could know the number of RA preamble transmitted in the non-last CE level as well as the number of RA preambles transmitted in last CE level. All of this information could play the same role as option2. eNB could increase the RA resource based on the number of RA preamble transmitted in each CE if it is larger than a threshold. Besides, the information in option5a and 5b could play the same role as the option6. In option5, 5a and 5b, the CE level(s) in the whole RA procedure could include the number of CE level(s) in the whole RA procedure, the initial CE level in the whole RA procedure, or the number of CE level except the last CE level in the whole RA procedure. Based on this information and the number of RA preamble transmitted in the last CE level or its variation, eNB could know the number of RA preamble transmission in each CE level.
Option6, the initial CE level and the number of RA preambles transmitted until the RA procedure is successful.
Based on the initial CE level during this successful RA procedure, the number of RA preambles transmitted until RA procedure is successful, and the maximum number of RA preambles transmitted in each CE level configured by eNB, eNB could know the number of RA preambles transmitted in each CE level. For example, if the maximum number of RA preambles transmitted in each CE level is 20, the initial CE level is 2, the number of RA preambles transmitted until RA procedure is successful is 39, it can be known that the number of RA preambles transmitted in CE level1 is 19. All the RA preambles information in each CE could be logically computed. eNB could execute the SON function based this information.
Option6a, the number of RA preambles transmitted until the RA procedure is successful, and the initial CE level and the corresponding number of RA preambles transmitted.
Option6b, the number of RA preambles transmitted until the RA procedure is successful, the initial CE level and the corresponding number of RA preambles transmitted, and the other CE level(s) than the last CE level UE has been in and the corresponding number of RA preambles transmitted.
Based on option6b, the number of RA preamble transmitted in last CE level could be computed by the difference of the number of RA preambles transmitted until the RA procedure is successful and the sum of the number of RA preambles transmitted in the initial CE level and in the other CE level(s) than the last CE level. Based on option6a, each CE level and its number of RA preamble transmitted could also be computed. Therefore eNB could adjust the RA parameters for SON or coverage.
Option7, the CE level(s) at which UE is failed to random access and the number of RA preambles transmitted in the CE level(s).
Option8, the last CE level when the RA procedure is successful and the number of RA preambles transmitted in last CE level.
For the above options, eNB may only want to know the information of the last CE level and the corresponding number of RA preamble transmitted. So small but efficient information will be transmitted to eNB to adjust the RA parameters or coverage.
Option9, the CE level(s) at which the number of RA preambles transmitted is larger than a threshold, and the number of RA preambles transmitted at the CE level(s).
Option10, the CE level(s) at which the number of RA preambles transmitted is no more than the threshold, and the number of RA preambles transmitted at the CE level(s).
Option9 and option10 have the similar function as option8. Just small but efficient information will be transmitted to eNB to adjust the RA parameters or coverage. eNB will adjust the RA parameters based on the number of RA preambles transmitted at the CE level. If the number is small for successful RA procedure, no SON is needed, else the SON needs to be executed.
Option11, the initial CE level and the last CE level during the RA procedure, and the number of RA preambles transmitted in the last CE level.
Based on the information of the initial CE level and the last CE level during the RA procedure, eNB could know the CE levels during the RA procedure because UE could only drop to another CE level one by one. Further, based on the number of RA preambles transmitted in the last CE, and the maximum number of RA preamble transmitted in each CE level, eNB could know the number of RA preamble transmitted in each CE level as well.

Besides the information associated with CE level, the following information could also be reported for network improving the RA performance or coverage:
Subcarrier information for the RA procedure. The subcarrier information indicates the subcarrier for each RA transmitting, or the subcarrier on which the number of times for failed RA transmitting is larger than a threshold, or the subcarrier information indicated the subcarrier for the dedicated RA preamble transmitting. The subcarrier information could also include the carrier information of the subcarrier. If UE failed to access network on some subcarriers, it means that the channel quality on these subcarriers is poor and the network could delete these subcarriers for RA procedure or avoid the interference on the resource from these subcarriers.
An indication indicating that the RA preambles are transmitted over the EDT(earlier data transmission) RA resource if the current RA resource is for a normal RA procedure.
This indication could help eNB to identify which RA resource needs to be optimized.
An indication indicating that the RA preamble is transmitted over the normal RA procedure if the current RA resource is for an EDT RA procedure.
This indication could help eNB to identify which RA resource needs to be optimized.
An indication indicating that the RA preambles are transmitted over the EDT(earlier data transmission) RA resource or the over the normal RA resource.
This indication could help eNB to identify which RA resource needs to be optimized.
An indication indicating that the RA preamble is transmitted over the grant-free RA resource.
This indication could help eNB to identify which RA resource needs to be optimized.
A contention resolution indication and its corresponding CE level information. If the contention resolution indication is true, it means at least of one of the RA preambles transmitting is for contention based RA.

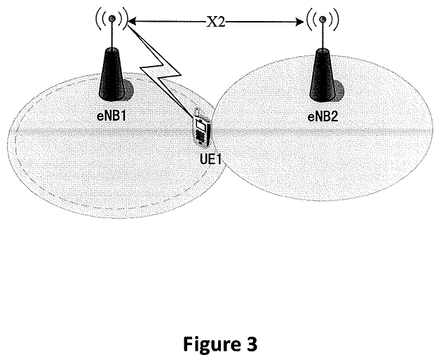

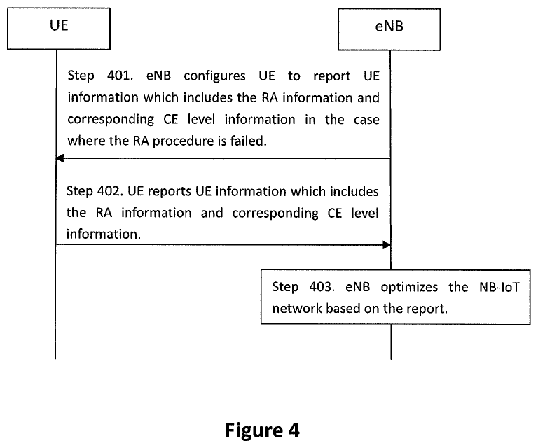

At step 203, eNB will optimize its RA resource configuration information, adjust the CE level, or performing some load related option. Please refer to FIG. 3.

In addition, UE may transmit the UE information to eNB autonomously without the request from eNB.

FIG. 3 is a schematic diagram illustrating a procedure for eNB to optimize the NB-IoT network according to one embodiment.

As shown in FIG. 3, the coverage of eNB1 and eNB2 are neighboring with each other with the edge overlapped. UE1 is in the coverage of eNB1 but out of the coverage of eNB2. UE1 transmits its UE information to eNB1. Further, eNB1 could transfer the UE information over the X2 interface to eNB2. In terms of network optimization, for example, if the number of RA preamble transmitted is too large in a CE level, eNB will increase the RA resource in this CE level, bar some UE in the cell selection/reselection procedure to unload UE, or improve the RSRP threshold of this CE level to unload UE. eNB1 will transfer its RA configuration for the CE level to eNB2 for RA optimization. This CE level information over X2 could be requested by eNB.

FIG. 4 is a schematic flow chart diagram illustrating a method for UE information transmission in NB-IoT network according to another embodiment.

In the case where the RA procedure is failed, UE information should be reported to eNB for network optimization. The failed RA procedure includes the failure in at least one of the following procedures, i.e. RLF procedure, RRC connection setup procedure, RRC connection reestablishment procedure, RRC connection request procedure, RRC connection resume request procedure, RRC connection established for Control Plane CIoT EPS Optimizations, RA for earlier data transmission procedure and the like.

In addition, as we know, NB-IOT system is a power saving, so only essential information needs to be reported to eNB, for example, the measurement results on serving cell, the measurement results on neighbor cell, the failed Pcell information, and the RLF cause (T310 expire, Random access, Maximum transmission in RLC layer). Here, if RLF is reported because of random access failed, the connected eNB should know the details for RA procedure.

At step 401, eNB will configure UE report its UE information which will include the RA information, and the information associated with CE level in RA failure procedure will also be requested. The configuration could be set by a Boolean value. This Boolean value is used to indicate whether the UE shall report information associated with CE level in the report.

At step 402, UE will report its UE information which will include the UE information. Also, the information associated with the CE level in the RA failure procedure will also be reported. In the case where the RA procedure is failed, the information associated with RA preamble and CE level could be transmitted based at least one of following options. Optionally, if RLF is trigger by random access failure, considering that RLF is triggered if RA preamble will be transmitted with the maximum times or RA failed in a configured timer, which means that the eNB has had the information of the real maximum RA preamble transmission number in RLF procedure, the following information could also be used for RLF report.
Option1, the number of RA preambles transmitted in each CE level.
For example, there are three CE levels in the current NB-IOT specification, UE needs to report its the number of RA preambles transmitted in each CE level of these threes CE levels, or the CE level is configured by dedicated RRC message or system information block. There are multiple CE levels UE may go through for one RA procedure. For example, there are 3 CE levels, and the maximum number of RA preambles transmitted in each CE level is 20. If the number of RA preambles transmitted reaches to 20 in one CE level, it will turn to the next CE level, and if it reaches the CE level with the smallest coverage (e.g. CE level0) the UE will stay in this CE level for multiple rounds for RA procedure. For example, the total number of RA preambles transmitted is 80, the number of RA preambles transmitted in the last CE level0 is 60, the number of RA preambles transmitted in the CE level 1 is 20, and the number of RA preambles transmitted in the CE level 2 is 0. eNB may adjust the RA configuration for each CE level based on this information. The CE level2 with number 0 means UE does not initiate RA procedure from this level, so no extra SON option will be trigged for the RA configuration for this CE level. However, for CE level1 and CE level0 the RA configuration could be adjusted based on the reported information. Especially for CE level 1, the number of RA preambles transmitted in this CE level reaches the threshold, so the network optimization for this level could be increasing the RA resource for UE access, such as the subcarrier resource or time resource, or adjusting the RSRP threshold for this CE level to make coverage range to be smaller than current value.
Option2, the number of RA preambles transmitted in the CE level UE has been in during the RA procedure.
This method could reduce the message size for information reporting. For example, UE only goes through two CE level, UE will just report the RA information associated with these two CE levels. eNB will adjust the RA configuration and coverage for these CE levels. For example, the maximum number of RA preambles transmitted at CE level1 is 20, the maximum number of RA preambles transmitted at CE level0 is 60. So the maximum number of RA preambles transmitted for the whole RA procedure is 80. The maximum number of RA preambles transmitted for the whole RA procedure could be configured to be a larger number for successful random access.
Option3, the number of RA preambles transmitted in last CE level when the RA procedure is failed, and the number of RA preambles transmitted until the RA procedure is failed.
Option4, the number of times for the UE circularly stay in the last CE level when the RA procedure is failed, the number of RA preambles transmitted in last CE level, and the number of RA preambles transmitted until the RA procedure is failed if the UE circularly stay in the last CE level for several rounds.
Option5, the number of times for the UE circularly stay in the last CE level when the RA procedure is failed, the number of RA preambles transmitted in the last round of the last CE and the number of RA preambles transmitted until the RA procedure is failed if the UE circularly stay in the last CE level for several rounds.
For option3, 4 and 5, eNB could compute the number of RA preambles transmitted in each CE level for failed RA procedure. Based on the number of RA preambles transmitted until the RA procedure is failed, and the configured maximum number of RA preamble transmitted in each CE level by eNB, eNB could know the number of RA preamble transmitted in the non-last CE level and the number of RA preambles transmitted in last CE level. eNB could increase the RA resource based on the number of RA preamble transmitted in each CE if it is larger than a threshold. The information in option3, 5 and 6 could play the same role as in option2. Based on this information and the number of RA preamble transmitted in the last CE level or its variation, eNB could know the number of RA preamble transmission in each CE level.
Option6, the initial CE level and the last CE level during the RA procedure.
Option7, the number of RA preambles transmitted in the initial CE level, and the number of RA preambles transmitted in the last CE level.
Based on option6 and 7, eNB could know the CE level information during the failed RA procedure. For example, for option7, if the initial CE level is level2, and the last CE level is level0, eNB will know that UE has been in CE level1, and the eNB will also adjust the RA configuration and coverage for CE level1. For example, for option9, eNB could know the maximum number of RA preambles transmitted until RA is failed and the maximum number of RA preamble transmitted in each CE level. Therefore based on the number of RA preambles transmitted in the initial CE level in the RA procedure, and the number of RA preambles transmitted in the last CE level in the PA procedure, eNB could know the CE level information during the failed RA procedure and the number of RA preambles transmitted in each CE level. If the number of RA preambles transmitted in initial CE level1 is 20, the maximum number of RA preamble transmitted until RA is failed is 60, it can be seen that UE transmitted the RA preamble in CE level0 for 40 times, which means UE stayed in the last CE level two rounds. eNB needs to adjust its RA parameters for this CE level.
Option8, the initial CE level and the number of RA preambles transmitted until the RA procedure is failed.
Based on the initial CE level during this failed RA procedure, the number of RA preambles transmitted until RA procedure is failed, and the maximum number of RA preambles transmitted in each CE level configured by eNB, eNB could compute the number of RA preambles transmitted in each CE level. For example, if the maximum number of RA preambles transmitted in each CE level is 20, the initial CE level is 2, the number of RA preamble transmitted until the RA procedure is failed is 39, it can be known that the number of RA preambles transmitted in CE level1 is 19. Then all the RA preamble information in each CE could be logically computed. eNB could execute the SON function based this information.
Option9, the CE level(s) at which the number of RA preambles transmitted is larger than a threshold, and the number of RA preambles transmitted in the CE level(s).
Option10, the CE level(s) at which the number of RA preambles transmitted is no more than the threshold, and the number of RA preambles transmitted in the CE level(s).
For option9 and opiton10, eNB could only adjust the RA configuration or coverage of the CE level at which the number of RA preambles transmitted is larger or smaller than a dedicated threshold.
Option11, the initial CE level and the last CE level during the RA procedure, and the number of RA preambles transmitted in the last CE, especially in the case that UE circularly stays in the last CE level for several rounds.
For example, the initial CE level is 2, the last CE level is 0, the total number of RA preambles transmitted in the last CE is 40, the maximum number of RA preamble in CE level2 and CE level0 is 20, the maximum number of RA preamble in the CE level1 is 30, the total number of RA preambles transmitted at all of the CE levels is 90. eNB may needs to adjust the total number of RA preambles transmitted in all of the CE levels for successful random access.

Besides the information associated with CE level, similarly to RA procedure, the following information could also be reported for network improving the RA performance or coverage.
Subcarrier information for the RA procedure.
The subcarrier information indicates the subcarrier for each RA transmitting, or the subcarrier on which the number of times for failed RA transmitting is larger than a threshold, or the subcarrier information indicated the subcarrier for the dedicate RA preamble transmitting. The subcarrier information could also include the carrier information of the subcarrier. If UE failed to access network on some subcarrier, it means that the channel quality on these subcarriers is poor and the network could delete these subcarriers for RA procedure or avoid the interference on the resource from these subcarriers.
The indication of RA preamble is transmitted over the EDT RA resource pool or normal RA resource pool or grant free RA resource.
This indication could help eNB to identify which RA resource needs to be optimized.
Contention resolution indication if this indication is true, which means at least one of the RA preamble transmitting is for contention based RA, and its CE level information.
This indication could help eNB to identify which RA resource needs to be optimized.

At step 403, eNB will optimize its RA resource configuration information, adjust CE level definition, or perform some load option based on the RLF report.

In addition, UE may transmit the UE information to eNB autonomously without the request from eNB.

According to another embodiment, the channel quality value also could be reported in the UE information. The channel quality value could be the measurement result associated with the CE level, for example, the measurement result when the CE level is changing, or the measurement results in a dedicated CE level. The channel quality value could be a threshold as the criteria to determine the CE level.

According to another embodiment, UE may notify eNB its RA timing or RLF timing. Alternatively, UE may notify eNB the occurring of RA or RLF before the RA configuration changed.

According to another embodiment, UE may notify eNB its RA parameters including the backoff value, or power information, or time for the whole RA procedure.

According to another embodiment, UE may notify eNB its RA reporting available information. The RA reporting available information is in RRCConnectionResumeComplet message, RRCEarlyDataRequest message, RRCConnectionResumeRequest, Msg.3 message, Msg.5 message, Msg.3 message for earlier data transmission for MO, Msg.5 message for earlier data transmission for MT, or Msg.3 message for earlier data transmission for MT.

According to another embodiment, UE may notify eNB its RLF reporting available information. The RLF reporting available information is in RRCConnectionResumeComplet message, RRCEarlyDataRequest message, RRCConnectionResumeRequest, Msg.3 message, Msg.5 message, Msg.3 message for earlier data transmission for MO, Msg.5 message for earlier data transmission for MT, or Msg.3 message for earlier data transmission for MT.

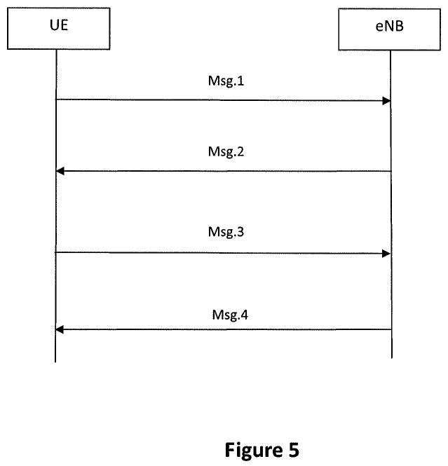

FIG. 5 is a schematic diagram illustrating the UE information transmission according to one embodiment.

In legacy LTE, random access procedure consists of four steps. First, UE transmits random access preamble in Msg.1 to eNB. Second, eNB transmits random access response in Msg.2 to UE. Third, UE transmits data or RRC connection request message in Msg.3 to eNB based on the information from Msg.2. Fourth, eNB responds with a contention resolution message in Msg.4 to UE.

Here, the RA reporting or RLF reporting is transmitted on the UE information response message. Usually, the information of SON request and SON response are transmitted after Msg.4. According to one embodiment, the information for request and response could be transmitted earlier and therefore the procedure may end earlier. In this way, some steps for information exchanging are omitted, which results in the benefit of power saving. Optional, UE could also transmit the RA reporting information or RLF reporting information above in the Msg.3 as EDT transmitted in Msg.3 in NB-IOT network for power saving. Furthermore, a request to report UE information for a RA procedure from an eNB could be transmitted in Msg.2 or Msg.4. The request to report UE information for a RA procedure from an eNB could be transmitted with a DL EDT data together for power saving.

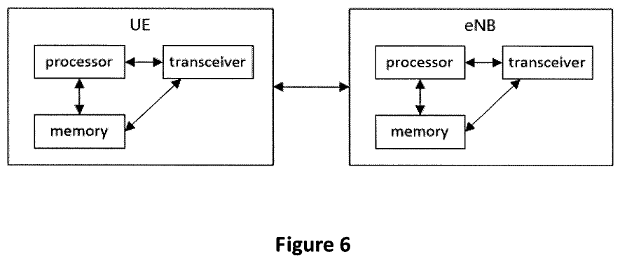

FIG. 6 is a schematic block diagram illustrating a UE and eNB.

Referring to FIG. 6, The UE includes a processor, a memory, and a transceiver. The processor implements a function, a process, and/or a method which are proposed in FIGS. 1 to 5 above. The eNB includes a processor, a memory, and a transceiver. The processors implement a function, a process, and/or a method which are proposed in FIGS. 1 to 5 above. Layers of a radio interface protocol may be implemented by the processors. The memories are connected with the processors to store various pieces of information for driving the processors. The transceivers are connected with the processors to transmit and/or receive a radio signal.

The memories may be positioned inside or outside the processors and connected with the processors by various well-known means. Further, the relay node may have a single antenna or multiple antennas.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

In the case of implementation by firmware or software, the embodiment may be implemented in the form of a module, a procedure, a function, and the like to perform the functions or operations described above. A software code may be stored in the memory and executed by the processor. The memory may be positioned inside or outside the processor and may transmit and receive data to/from the processor by various means.

1. A method at a user equipment for transmitting the user equipment information in a wireless communication system, the method comprising:
transmitting the user equipment information to an e-NodeB,
wherein the user equipment information includes random access preamble transmission information and its coverage enhancement level information or includes a radio link failure report and its coverage enhancement level information.

2. The method of claim 1, further comprising:
receiving a request to report the user equipment information for the random access procedure from the e-NodeB; and
reporting the user equipment information to the e-NodeB in response to the request.

3. The method of claim 1, wherein the random access preamble transmission information and its coverage enhancement level information are for the case where the random access procedure is successful, and the radio link failure report and its coverage enhancement level information are for the case where the random access procedure is failed.

4. The method of claim 1, wherein the random access preamble transmission information and its coverage enhancement level information in the case where the random access procedure is successful include at least one of the following information:
the number of random access preambles transmitted until the random access procedure is successful, and the coverage enhancement level when the random access procedure is successful,
the number of random access preambles transmitted in each coverage enhancement level,
the number of random access preambles transmitted in each coverage enhancement level the user equipment has been in during the random access procedure,
the number of random access preambles transmitted until the random access procedure is successful and the number of random access preambles transmitted in the last coverage enhancement level when the random access procedure is successful,
the coverage enhancement level(s) in the whole random access procedure, the number of times for the user equipment circularly stay in the last coverage enhancement level when the random access procedure is successful,
the initial coverage enhancement level and the number of random access preambles transmitted until the random access procedure is successful,
the coverage enhancement level(s) at which user equipment is failed to random access and the number of random access preambles transmitted in the coverage enhancement level(s),
the last coverage enhancement level when the random access procedure is successful and the number of random access preambles transmitted in last coverage enhancement level,
the coverage enhancement level(s) at which the number of random access preambles transmitted is larger than a threshold, and the number of random access preambles transmitted at the coverage enhancement level(s),
the coverage enhancement level(s) at which the number of random access preambles transmitted is no more than the threshold, and the number of random access preambles transmitted at the coverage enhancement level(s), or
the initial coverage enhancement level and the last coverage enhancement level during the random access procedure, and the number of random access preambles transmitted in the last coverage enhancement level.

5. The method of claim 1, wherein the user equipment information in the case where the random access procedure is successful further includes at least one of the following information:
subcarrier information for the random access procedure,
an indication indicating that the random access preambles are transmitted over the earlier data transmission random access resource if the current random access resource is for a normal random access procedure,
an indication indicating that the random access preamble is transmitted over the normal random access procedure if the current random access resource is for an earlier data transmission random access procedure,
an indication indicating that the random access preambles are transmitted over the earlier data transmission random access resource or the over the normal random access resource,
an indication indicating that the random access preamble is transmitted over the grant-free random access resource, or
a contention resolution indication and its corresponding coverage enhancement level information, wherein if the contention resolution indication is true, it means at least one of the random access preambles transmitting is for contention based random access.

6. The method of claim 1, wherein the random access preamble transmission information and its coverage enhancement level information in the case where the random access procedure is failed include at least one of the following information:
the number of random access preambles transmitted in each coverage enhancement level,
the number of random access preambles transmitted in the coverage enhancement level user equipment has been in during the random access procedure,
the number of random access preambles transmitted in last coverage enhancement level when the random access procedure is failed, and the number of random access preambles transmitted until the random access procedure is failed,
the number of times for the user equipment circularly stay in the last coverage enhancement level when the random access procedure is failed, the number of random access preambles transmitted in last coverage enhancement level, and the number of random access preambles transmitted until the random access procedure is failed if the user equipment circularly stay in the last coverage enhancement level for several rounds,
the number of times for the user equipment circularly stay in the last coverage enhancement level when the random access procedure is failed, the number of random access preambles transmitted in the last round of the last coverage enhancement and the number of random access preambles transmitted until the random access procedure is failed if the user equipment circularly stay in the last coverage enhancement level for several rounds,
the initial coverage enhancement level and the last coverage enhancement level during the random access procedure,
the number of random access preambles transmitted in the initial coverage enhancement level, and the number of random access preambles transmitted in the last coverage enhancement level,
the initial coverage enhancement level and the number of random access preambles transmitted until the random access procedure is failed,
the coverage enhancement level(s) at which the number of random access preambles transmitted is larger than a threshold, and the number of random access preambles transmitted in the coverage enhancement level(s),
the coverage enhancement level(s) at which the number of random access preambles transmitted is no more than the threshold, and the number of random access preambles transmitted in the coverage enhancement level(s), or
the initial coverage enhancement level and the last coverage enhancement level during the random access procedure, and the number of random access preambles transmitted in the last coverage enhancement.

7. The method of claim 1, wherein the user equipment information in the case where the random access procedure is failed further includes at least one of the following information:
subcarrier information for the random access procedure,
an indication indicating whether the random access preambles are transmitted over an earlier data transmission random access resource pool or a normal random access resource pool or grant free random access resource, or
a contention resolution indication and its corresponding coverage enhancement level information, wherein if the contention resolution indication is true, it means at least one of the random access preambles transmitting is for contention based random access.

8. The method of claim 1, wherein the user equipment information is transmitted in Msg.3.

9. The method of claim 6, wherein the user equipment information is transmitted in Msg.3 with an earlier data transmission data together.

10. The method of claim 1, wherein the request is transmitted in Msg.2 or Msg.4.

11. The method of claim 9, wherein the request is transmitted in Msg.2 or Msg.4 with an earlier data transmission data together.

12. (canceled)

13. A method at e-NodeB for receiving user equipment information in a wireless communication system, the method comprising:
receiving the user equipment information from the user equipment,
wherein the user equipment information includes random access preamble transmission information and its coverage enhancement level information or includes a radio link failure report and its coverage enhancement level information.

14. (canceled)

15. The method of claim 13, wherein the random access preamble transmission information and its coverage enhancement level information are for the case where the random access procedure is successful and the radio link failure report and its coverage enhancement level information are for the case where the random access procedure is failed.

16. The method of claim 13, wherein the random access preamble transmission information and its coverage enhancement level information in the case where the random access procedure is successful include at least one of the following information:
the number of random access preambles transmitted until the random access procedure is successful, and the coverage enhancement level when the random access procedure is successful,
the number of random access preambles transmitted in each coverage enhancement level,
the number of random access preambles transmitted in each coverage enhancement level the user equipment has been in during the random access procedure,
the number of random access preambles transmitted until the random access procedure is successful and the number of random access preambles transmitted in the last coverage enhancement level when the random access procedure is successful,
the coverage enhancement level(s) in the whole random access procedure, the number of times for the user equipment circularly stay in the last coverage enhancement level when the random access procedure is successful,
the initial coverage enhancement level and the number of random access preambles transmitted until the random access procedure is successful,
the coverage enhancement level(s) at which user equipment is failed to random access and the number of random access preambles transmitted in the coverage enhancement level(s),
the last coverage enhancement level when the random access procedure is successful and the number of random access preambles transmitted in last coverage enhancement level,
the coverage enhancement level(s) at which the number of random access preambles transmitted is larger than a threshold, and the number of random access preambles transmitted at the coverage enhancement level(s),
the coverage enhancement level(s) at which the number of random access preambles transmitted is no more than the threshold, and the number of random access preambles transmitted at the coverage enhancement level(s), or
the initial coverage enhancement level and the last coverage enhancement level during the random access procedure, and the number of random access preambles transmitted in the last coverage enhancement level.

17. The method of claim 13, wherein the user equipment information in the case where the random access procedure is successful further includes at least one of the following information:
subcarrier information for the random access procedure,
an indication indicating that the random access preambles are transmitted over the earlier data transmission (earlier data transmission) random access resource if the current random access resource is for a normal random access procedure,
an indication indicating that the random access preamble is transmitted over the normal random access procedure if the current random access resource is for an earlier data transmission random access procedure,
an indication indicating that the random access preambles are transmitted over the earlier data transmission random access resource or the over the normal random access resource,
an indication indicating that the random access preamble is transmitted over the grant-free random access resource, or
a contention resolution indication and its corresponding coverage enhancement level information, wherein if the contention resolution indication is true, it means at least one of the random access preambles transmitting is for contention based random access.

18. (canceled)

19. The method of claim 13, wherein the user equipment information in the case where the random access procedure is failed further includes at least one of the following information:
subcarrier information for the random access procedure,
an indication indicating whether the random access preambles are transmitted over an earlier data transmission random access resource pool or a normal random access resource pool or grant free random access resource, and
a contention resolution indication and its corresponding coverage enhancement level information, wherein if the contention resolution indication is true, it means at least one of the random access preambles transmitting is for contention based random access.

20. The method of claim 13, wherein the user equipment information is transmitted in Msg.3.

21. (canceled)

22. (canceled)

23. (canceled)

24. (canceled)

25. A user equipment for reporting the user equipment information to an e-NodeB, the user equipment comprising:
a transceiver;
a processor is configured to control the transceiver to:
receive a request to report user equipment information for a random access procedure from an e-NodeB;
report the user equipment information to the e-NodeB in response to the request,
wherein the user equipment information includes random access preamble transmission information and its coverage enhancement level information or includes a radio link failure report and its coverage enhancement level information.

26. (canceled)

27. The user equipment of claim 25, wherein the random access preamble transmission information and its coverage enhancement level information in the case where the random access procedure is successful include at least one of the following information:
the number of random access preambles transmitted until the random access procedure is successful, and the coverage enhancement level when the random access procedure is successful,
the number of random access preambles transmitted in each coverage enhancement level,
the number of random access preambles transmitted in each coverage enhancement level the user equipment has been in during the random access procedure,
the number of random access preambles transmitted until the random access procedure is successful and the number of random access preambles transmitted in the last coverage enhancement level when the random access procedure is successful,
the coverage enhancement level(s) in the whole random access procedure, the number of times for the user equipment circularly stay in the last coverage enhancement level when the random access procedure is successful,
the initial coverage enhancement level and the number of random access preambles transmitted until the random access procedure is successful,
the coverage enhancement level(s) at which user equipment is failed to random access and the number of random access preambles transmitted in the coverage enhancement level(s),
the last coverage enhancement level when the random access procedure is successful and the number of random access preambles transmitted in last coverage enhancement level,
the coverage enhancement level(s) at which the number of random access preambles transmitted is larger than a threshold, and the number of random access preambles transmitted at the coverage enhancement level(s),
the coverage enhancement level(s) at which the number of random access preambles transmitted is no more than the threshold, and the number of random access preambles transmitted at the coverage enhancement level(s), or
the initial coverage enhancement level and the last coverage enhancement level during the random access procedure, and the number of random access preambles transmitted in the last coverage enhancement level.

28. The user equipment of claim 25, wherein the user equipment information in the case where the random access procedure is successful further includes at least one of the following information:
subcarrier information for the random access procedure,
an indication indicating that the random access preambles are transmitted over the earlier data transmission (earlier data transmission) random access resource if the current random access resource is for a normal random access procedure,
an indication indicating that the random access preamble is transmitted over the normal random access procedure if the current random access resource is for an earlier data transmission random access procedure,
an indication indicating that the random access preambles are transmitted over the earlier data transmission (earlier data transmission) random access resource or the over the normal random access resource,
an indication indicating that the random access preamble is transmitted over the grant-free random access resource, or
a contention resolution indication and its corresponding coverage enhancement level information, wherein if the contention resolution indication is true, it means at least one of the random access preambles transmitting is for contention based random access [[RA]].

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)
